(19) United States
(12) Patent Application Publication
(10) Pub. No.: US 2025/0328891 A1
(43) Pub. Date: Oct. 23, 2025

(54) INTER-DEVICE COMMUNICATION FOR INTER-PARTY ACTION

(71) Applicant: Truist Bank, Charlotte, NC (US)

(72) Inventors: Hayden Rebecca Thomas, Charlotte, NC (US); Jamie Nathaniel Franklin, Charlotte, NC (US)

(73) Assignee: Truist Bank, Charlotte, NC (US)

(21) Appl. No.: 18/643,353

(22) Filed: Apr. 23, 2024

(51) Int. Cl. G06Q 20/32

(52) U.S. Cl. CPC G06Q 20/3278; G06Q 20/326

(57) ABSTRACT

A method for cash transfer using near-field communication (NFC) between two mobile devices. Two devices are brought into close physical proximity and establish NFC. A pop-up notification is provided on at least one of the devices, offering the option for the users to establish each other as contacts, and the option to perform a one-time cash transfer. Establishment of contacts is accomplished by merely initiating a contact request on one mobile device and accepting the request on the other device, each involving a single button click. Execution of a cash transfer is accomplished by simply sending a defined amount from one device to the other proximal device, or by requesting a cash transfer from one device and approving the transfer on the other device. The physical proximity of the mobile devices and the users' inter-personal communication ensure that the contact creation and cash transfer are secure.

### FIELD

The present disclosure relates generally to the field of digital banking data systems, and more particularly to a system and method for conveniently establishing a peer-to-peer near-field communication connection in a cash transfer application running on user mobile devices, sharing contact information and completing a cash transfer transaction using the application and the established peer-to-peer connection.

### BACKGROUND

Cash transfer applications are known which allow the transfer of money from one entity to another, where the entities may be individual persons or businesses. A common and preferred mode of using these cash transfer applications is on mobile devices such as smartphones, where the cash transfer application runs as a mobile application (“app”).

Although the use of these cash transfer apps on a mobile device can be simple and convenient, it is necessary for two parties to establish each other as contacts in the cash transfer app before sending money. Unfortunately, the process of two people mutually establishing each other as contacts in a cash transfer app can be unintuitive and time-consuming, especially for the non-tech-savvy user. The process typically involves asking for phone number or email address information, sending a text message or an email, replying to the text message or email, receiving a security code and entering the security code in the app to approve and authenticate the contact.

Most modern mobile devices include several types of communication systems—including the inherent cellular radio, a WiFi transceiver, and possibly others. Some communication technologies available on mobile devices, such as near-field communication (NFC), operate only over a very short range. Although this short operational range prevents the use of NFC over significant distances, the short range may be used as a feature by requiring and ensuring physical proximity when performing certain operations with mobile devices.

In light of the circumstances described above, there is a need for an improved method of using cash transfer apps which utilizes very short range mobile device communication capability to enable more convenient peer-to-peer operation.

### BRIEF SUMMARY

The present disclosure describes a method for convenient peer-to-peer cash transfer using near-field communication (NFC) between two users' mobile devices. The two mobile devices are brought into close physical proximity, which generally means within a few centimeters, in order establish NFC connectivity. When at least one of the mobile devices has the cash transfer app installed, a pop-up notification is provided, where the notification offers the option for the two users to establish each other as contacts in the cash transfer app if they are not already, and the option to perform a one-time cash transfer. Establishment of contacts is accomplished by merely initiating a contact request on one mobile device and accepting the contact request on the other device, each involving a single button click. Execution of an actual cash transfer is accomplished by simply sending a defined monetary amount from one mobile device to the other proximal device, or by requesting a cash payment from one device and approving the payment on the other device. The physical proximity of the mobile devices and the inter-personal communication between the two users ensure that the contact creation and the actual cash transfer are secure and appropriate.

The features, functions, and advantages that have been discussed may be achieved independently in various embodiments of the present disclosure or may be combined in yet other embodiments, further details of which can be seen with reference to the following description and drawings, along with the appended claims.

### BRIEF DESCRIPTION OF THE DRAWINGS

FIG. 1 illustrates an enterprise system, and environment thereof, including a centralized server system, distributed computers and mobile devices, and communication therebetween, according to at least one embodiment of the present disclosure;

FIG. 2 is a simplified illustration of the enterprise system of FIG. 1, showing the elements most directly involved in the NFC-enabled cash transfer app as embodied in the techniques of the present disclosure;

FIG. 3 is an illustration of two mobile devices brought into physical proximity and establishing a near-field communication (NFC) connection for the purpose of conveniently using a peer-to-peer cash transfer application, according to an embodiment of the present disclosure;

FIG. 4 is a mock-up illustration of a display screen on a mobile device, illustrating a notification from the cash transfer application of a nearby user and offering options for interaction with the user in the application, according to an embodiment of the present disclosure;

FIG. 5 is a mock-up illustration of a display screen on a mobile device, illustrating a notification from the cash transfer application that a nearby user would like to mutually establish contacts in the application, according to an embodiment of the present disclosure;

FIG. 6 is a mock-up illustration of a display screen on a mobile device, illustrating options provided for sending or requesting a cash transfer in the application, according to an embodiment of the present disclosure;

FIG. 7 is a mock-up illustration of a display screen on a mobile device, illustrating a notification from the cash transfer application that the nearby user has completed a cash transfer in the application, according to an embodiment of the present disclosure;

FIG. 8 is a mock-up illustration of a display screen on a mobile device, illustrating a notification from the cash transfer application that the nearby user has requested a cash transfer payment in the application, according to an embodiment of the present disclosure; and

FIG. 9 is a flowchart diagram of a method for establishing contacts and sending money using a cash transfer application on mobile devices communicating via near-field communication (NFC), according to an embodiment of the present disclosure.

### DETAILED DESCRIPTION OF EMBODIMENTS

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

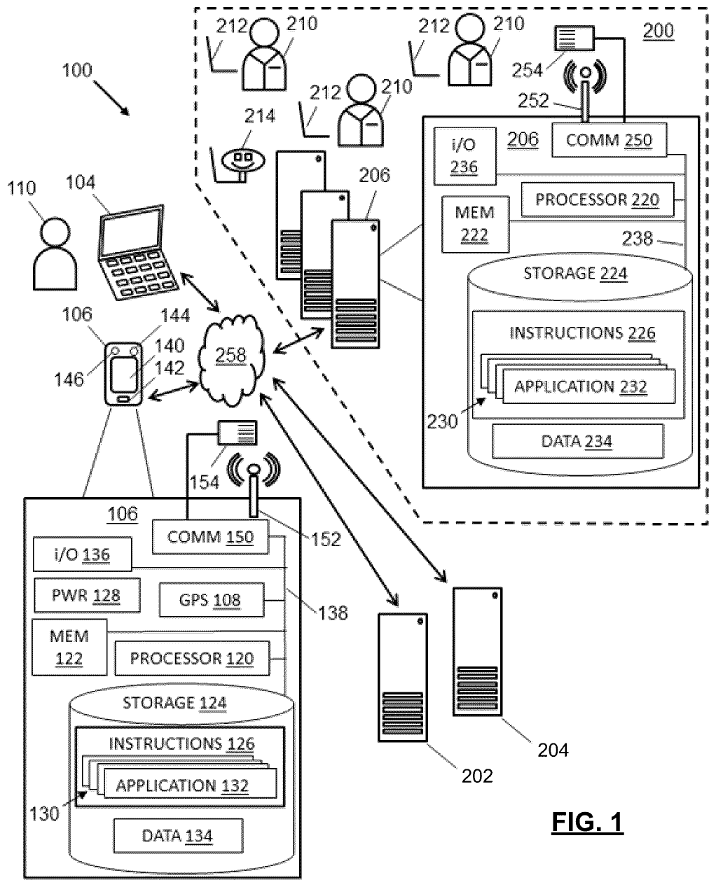

FIG. 1 illustrates a system 100 and environment thereof, including centralized and distributed computing devices, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to implement stored processing, such as decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

One type of algorithm suitable for use in machine learning modules as described herein is an artificial neural network or neural network, taking inspiration from biological neural networks. An artificial neural network can, in a sense, learn to perform tasks by processing examples, without being programmed with any task-specific rules. A neural network generally includes connected units, neurons, or nodes (e.g., connected by synapses) and may allow for the machine learning program to improve performance. A neural network may define a network of functions, which have a graphical relationship. As an example, a feedforward network may be utilized, e.g., an acyclic graph with nodes arranged in layers.

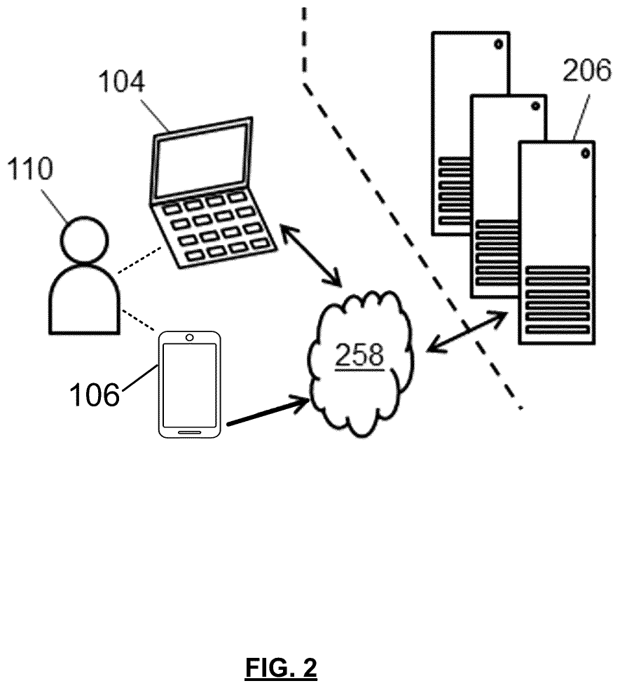

FIG. 2 is a simplified illustration of the enterprise architecture depicted in FIG. 1, showing the elements most directly involved in using online/digital banking systems. The user 110 (e.g., a client) uses either the computing device 104 or the mobile device 106 to access a digital banking system, where the computing device 104 would run a web browser application in which the digital banking system is displayed, and the mobile device 106 would run a mobile application (“app”) specifically designed as the digital banking system. The computing device 104 and/or the mobile device 106 communicate with the computing system (back-end servers) 206 via the network (“the cloud”) 258.

Banking customers have at least one account, and often more than one account, with a bank business. These accounts may include savings accounts, checking accounts, investment accounts, credit cards, loans, mortgages, etc. Online/digital banking systems are now widely used because they enable clients to conveniently perform most banking functions electronically-including opening accounts, transferring money between accounts, paying bills, viewing transaction details, etc. The use of online/digital banking systems as related to the techniques of the present disclosure will be illustrated in later figures and described in the discussion accompanying those figures.

Having described an enterprise computing environment as might be used by a banking business, and general characteristics of systems including online and digital banking systems which may be employed in the enterprise computing environment, attention is now turned to the specific topic of the present disclosure-a method and system for using a cash transfer app in a manner which takes advantage of mobile device near-field communication capability.

As has been discussed above, bank businesses operate many different types of computer systems and databases-including the online and digital banking systems discussed immediately above. Along with the bank's digital banking system running as a mobile application (app), it is common for users (clients) to also have a cash transfer app which is directly tied to one of the client's accounts at the bank.

The techniques of the present disclosure describe a system architecture developed to enable a cash transfer app to operate in a manner which is more efficient and convenient for the users, by using the physical proximity of the users' mobile devices to ensure targeted and secure transactions. This system architecture and the underlying design elements, along with examples of how the system is used for establishing contacts and performing cash transfers, are depicted in the remaining figures and discussed below.

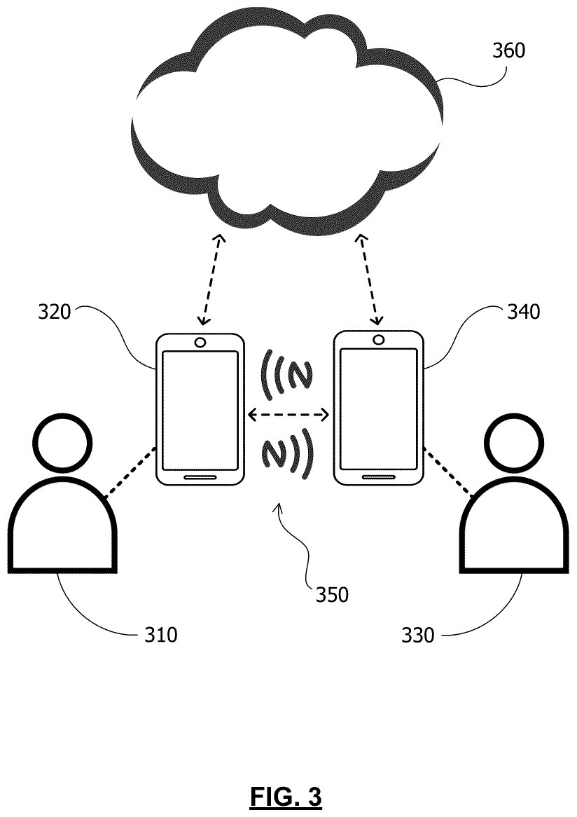

FIG. 3 is an illustration of two mobile devices brought into close physical proximity and establishing a near-field communication (NFC) connection for the purpose of conveniently using a peer-to-peer cash transfer application, according to an embodiment of the present disclosure. A user 310 has a mobile device 320, and a user 330 has a mobile device 340. The user 310 and the user 330, as an example, may be together at a restaurant table where they are in visual and verbal contact. When the mobile devices 320 and 340 are placed in close physical proximity, they establish NFC communication, as indicated at 350.

Near-field communication (NFC) is a set of communication protocols that enables communication between two electronic devices over a very short distance. NFC offers a low-speed connection through a simple setup that can be used for its own communication purposes or for the bootstrapping of other wireless communication technologies. NFC is based on inductive coupling between two electromagnetic coils present on NFC-enabled devices such as smartphones. NFC devices communicating in one or both directions use a frequency of 13.56 megahertz (MHZ). The effective range of NFC for inter-device connectivity is on the order of a few centimeters (cm)—such as less than five cm. Most modern mobile devices (e.g., smartphones) include NFC capability.

Other communication technologies and combinations thereof may be employed in the techniques of the present disclosure. For example, NFC may be used to establish the close physical proximity of the mobile devices and initiate device-to-device communication, and thereafter a communication technology having a higher bandwidth (such as Bluetooth or peer-to-peer WiFi) may be used for ongoing device-to-device communication and transaction execution, potentially dependent upon the close physical proximity of the devices being maintained.

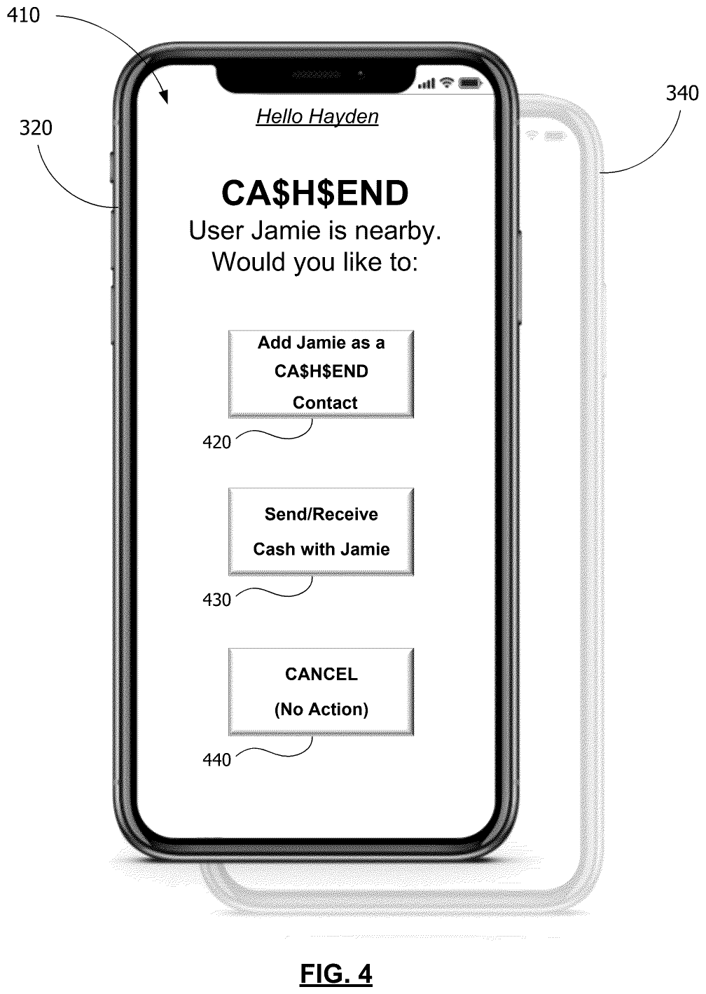

The mobile devices 320 and 340 are also understood to be in communication with any and all needed server-based and internet-based systems, as represented by a cloud 360. Via the cloud 360, the mobile apps running on the devices 320 and 340 communicate with the servers necessary for information exchange and transaction execution, as discussed earlier with respect to FIG. 1 and as understood by those skilled in the art. The mobile devices 320 and 340 of FIG. 3, in close physical proximity and communicating via NFC, are used in the implementation examples depicted in FIGS. 4-8.

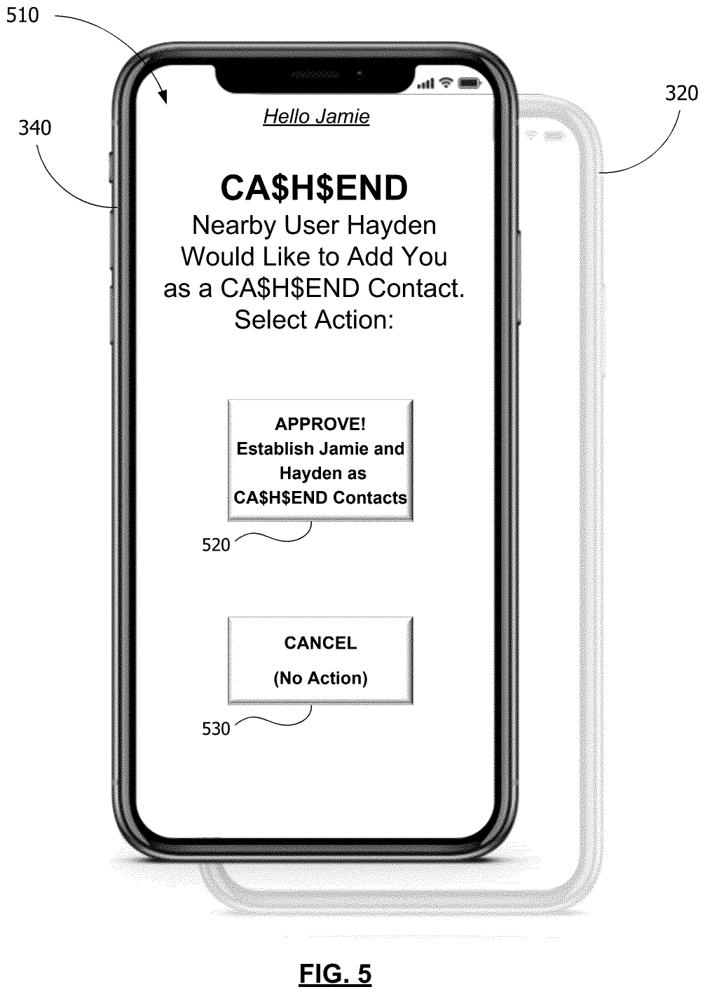

FIG. 4 is a mock-up illustration of a display screen 410 on the mobile device 320, illustrating a notification from the cash transfer application of a nearby user and offering options for interaction with the user in the application, according to an embodiment of the present disclosure. In FIG. 4, the mobile device 320 (belonging to a user Hayden) is shown in the foreground with the display screen 410, while the mobile device 340 is partially visible in the background (indicating that it is in close physical proximity). This same drawing arrangement is also used in FIGS. 5-8, to illustrate the interactions involved in the presently disclosed methodology, where in some figures the mobile device 340 (belonging to a user Jamie) is in the foreground.

Near the top of the display screen 410, a message from a fictitious cash transfer app called “CASH$END” is displayed. “CASH$END” is generically meant to represent any existing cash transfer app-such as Zelle®, Venmo, etc.—or any future cash transfer app, which may take advantage of the presently disclosed techniques for convenience and simplicity enabled by secure NFC inter-device communication.

The message on the display screen 410 indicates that another user of the CASH$END app is nearby, meaning the other user device (the mobile device 340 belonging to Jamie) is within NFC range. This would happen when the two users purposely bring their mobile devices very close together (within a few cm)—such as by holding the devices back to back. Automatic detection and establishment of NFC communication with another device is a known capability of modern mobile devices. Using this detected NFC communication channel to launch the cash transfer app and initiate the secure and convenient sharing of contact information and/or the transfer of money is the subject of the present disclosure.

The display screen 410 is simply illustrative of any type of app screen, push notification, or other pop-up message which may be displayed on a mobile device. It is to be understood that the design of the display screens, the use of buttons versus checkboxes versus radio buttons, the options and option wording, and other design features are all variable from one implementation to another based on design preference.

The situation in FIG. 4 is that, upon detection of the NFC communication channel, the mobile device 320 queries the mobile device 340 to determine the identity of its owner, and also whether the mobile device 340 has the CASHSEND app installed. In the current scenario, the mobile device 340 (of Jamie) already has the CASH$END app installed, and both users are immediately able to interact using the app. In another scenario, where one device has the CASH$END app installed and the other does not, a first step would be to prompt the other device to install the CASH$END app.

On the display screen 410, after being informed of the CA$H$END user Jamie nearby, Hayden is offered the option to add Jamie as a CASH$END contact (using a button 420), or directly perform a cash transfer transaction with Jamie (using a button 430), or cancel (take no action-using a button 440). Adding the other user as a contact would not be displayed as an available action button if the two users are already mutual contacts in the CASH$END app. Adding the other user as a contact and directly performing a cash transfer transaction are discussed further with respect to the following figures.

FIG. 5 is a mock-up illustration of a display screen 510 on the mobile device 340, illustrating a notification from the cash transfer application that the nearby user would like to mutually establish contacts in the application, according to an embodiment of the present disclosure. In FIG. 5, the mobile device 340 of Jamie is in the foreground, and the mobile device 320 of Hayden is in the background and within NFC range. The display screen 510 of FIG. 5 illustrates a next step when the button 420 of FIG. 4 (add Jamie as a CASH$END contact) is pressed by Hayden. In FIGS. 5-8, the mobile devices 320 and 340 are depicted as being in close physical proximity. However, it is only strictly necessary that the devices be in close physical proximity and have an NFC channel established for the first interaction shown in FIG. 4. Thereafter, the mobile devices 320 and 340 may be moved further apart and continue interaction via a different communication channel (i.e., something other than NFC, such as WiFi or Bluetooth).

At the top of the display screen 510, CA$H$END notifies Jamie that the nearby CASH$END user Hayden would like to add Jamie as a contact in the CASHSEND app. By clicking a button 520, Jamie approves being added as a contact in Hayden's CASHSEND account, and preferably also creates Hayden as a contact in Jamie's own CASHSEND account. If either user is already established as a contact in the other user's CASHSEND account, then the actions triggered by pressing the buttons 420 and 520 adds the CASHSEND contact which was not previously in place. A button 530 on the display screen 510 allows the user Jamie to decline the contact setup request from Hayden.

To summarize what has happened-after the two mobile devices were brought within NFC range, one user (Hayden, on FIG. 4) clicked a button to add the other user as a contact, and the other user (Jamie, on FIG. 5) clicked a button to approve the request and establish Hayden and Jamie as mutual contacts in the CASH$END app. These simple steps accomplish what requires multiple manual steps using existing cash transfer app methods-those steps including the users exchanging email address and/or mobile phone number information with each other, sending emails and/or text messages back and forth, performing actions and entering data in the cash transfer app, receiving and entering one-time security codes in the app, etc.

The techniques of the present disclosure are vastly more simple than the techniques required using existing systems, yet the presently disclosed techniques provide just as much security. The security inherent in the presently disclosed method stems from several factors: first, the users have deliberately brought their mobile devices into close physical proximity (NFC range); second, the users are in visual and verbal contact with each other, and will have agreed by inter-personal communication to perform the action in the CASH$END app; and third, the action in the CA$H$END app requires a button click by each user to initiate or approve. In addition, it is to be understood that the actions depicted in FIGS. 4-8 can only be performed when the respective user's mobile device is unlocked-such as by facial recognition or by entering a passcode. The unlocking ensures that each mobile device is in the possession and control of its rightful owner. Thus, the use of NFC for establishing contacts in a cash transfer app provides a tremendous improvement in convenience, while maintaining a high level of security which is required in a cash transfer app.

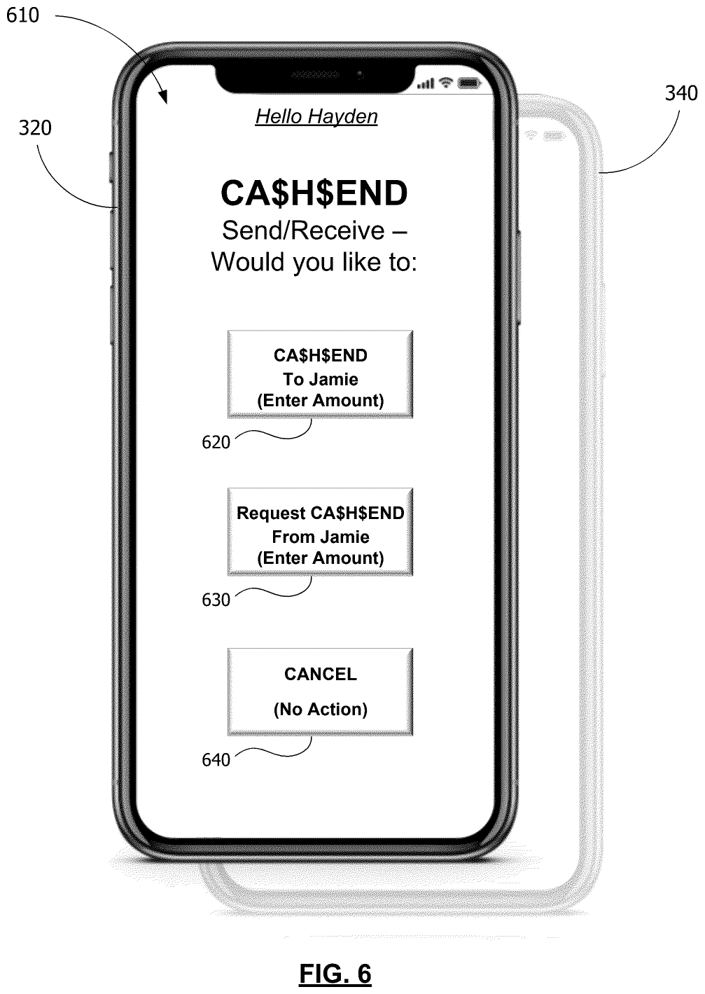

FIG. 6 is a mock-up illustration of a display screen 610 on the mobile device 320, illustrating options provided for sending or requesting a cash transfer in the CASHSEND application, according to an embodiment of the present disclosure. In FIG. 6, the mobile device 320 of Hayden is in the foreground, and the mobile device 340 of Jamie is in the background. The display screen 610 of FIG. 6 illustrates a next step when the button 430 of FIG. 4 (send/receive cash with Jamie) is pressed by Hayden. Rather than selecting a send/receive cash option on one screen and then selecting either send or request payment on another screen, it is also possible to provide a separate send cash button and a request payment button on the display screen 410 of FIG. 4.

At the top of the display screen 610, CA$H$END asks Hayden which of two send/receive options is desired. A button 620 allows Hayden to send cash to Jamie using the CASHSEND app. When the button 620 is pressed, the CASH$END prompts Hayden to enter the amount of money to send to Jamie. The amount entry prompt could be displayed on the display screen 610, or in a pop-up window, or on a separate display screen altogether. In a preferred embodiment, once an amount is entered by Hayden, another button needs to be pressed to execute the cash transfer transaction.

A button 630 allows Hayden to request a cash payment from Jamie using the CA$HSEND app. When the button 630 is pressed, the CASH$END prompts Hayden to enter the amount of the payment to request from Jamie. Again, the amount entry prompt could be displayed on the display screen 610, or in a pop-up window, or on a separate display screen altogether. In a preferred embodiment, once a requested payment amount is entered by Hayden, another button is pressed to send the payment request to Jamie's CASH$END account. A button 640 allows Hayden to cancel the cash send/receive operation without taking any action. When the button 620 or the button 630 is selected by Hayden (along with the amount entry), a corresponding notification is provided to Jamie, as discussed with respect to the following figures.

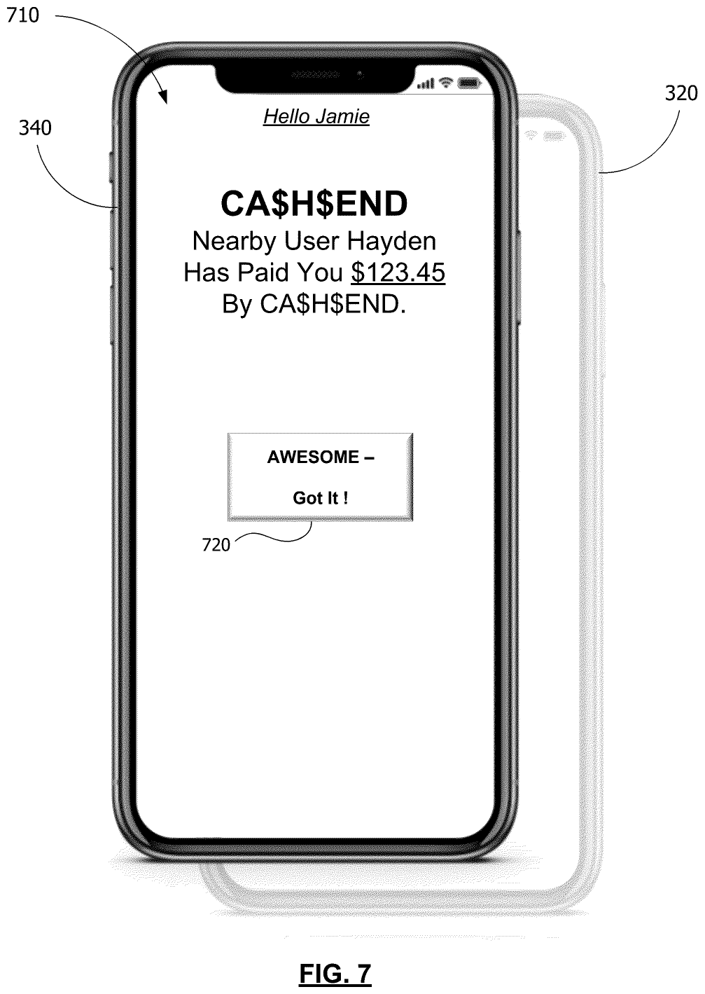

FIG. 7 is a mock-up illustration of a display screen 710 on the mobile device 340, illustrating a notification from the cash transfer application that the nearby user has completed a cash transfer in the application, according to an embodiment of the present disclosure. In FIG. 7, the mobile device 340 of Jamie is in the foreground, and the mobile device 320 of Hayden is in the background. The display screen 710 of FIG. 7 illustrates a next step when the button 620 of FIG. 6 (send cash, then enter amount and OK) is pressed by Hayden.

At the top of the display screen 710, CA$H$END notifies Jamie that Hayden has sent cash in the amount of $123.45 to Jamie. This is the type of notification that would be received by the recipient of a CASH$END cash transfer. No action is required by Jamie other than to acknowledge that the incoming cash transfer has been completed, which acknowledgement may be performed by pressing a button 720.

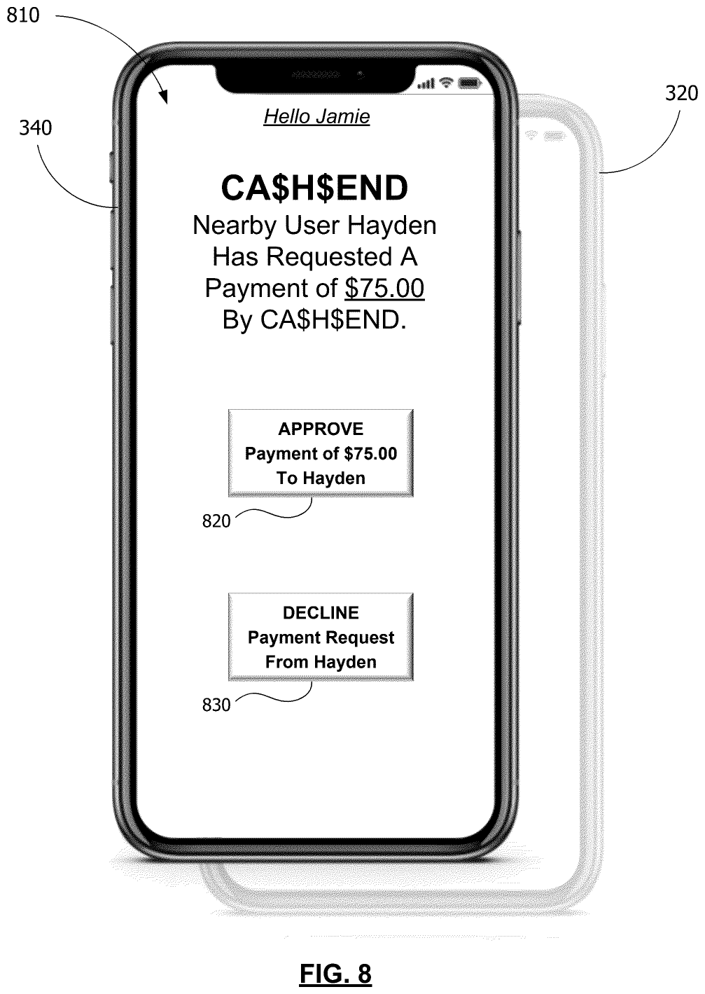

FIG. 8 is a mock-up illustration of a display screen 810 on the mobile device 340, illustrating a notification from the cash transfer application that the nearby user has requested a cash transfer payment in the application, according to an embodiment of the present disclosure. In FIG. 8, the mobile device 340 of Jamie is in the foreground, and the mobile device 320 of Hayden is in the background. The display screen 810 of FIG. 8 illustrates a next step when the button 630 of FIG. 6 (request a cash payment from Jamie, enter amount and OK) is pressed by Hayden.

At the top of the display screen 810, CASH$END notifies Jamie that Hayden has requested that Jamie send a cash payment in the amount of $75.00. This is the type of notification that would be received upon a CA$H$END cash transfer request. Jamie can approve and execute the payment of $75.00 to Hayden by pressing a button 820. Jamie can decline to make the payment to Hayden by pressing a button 830.

Again it is emphasized that the two users are in visual and verbal contact with each other during the time when the CA$H$END actions and transactions are taking place. Thus, it is unlikely that the cash transfer request is a surprise to Jamie when it appears on the display screen 810. Nevertheless, it is possible that Jamie may want to decline the payment request from Hayden-because the amount was calculated or entered incorrectly by Hayden, or for some other reason. For these reasons it is desirable to provide the button 830 to allow a user to decline the payment request.

Another feature that may be provided is to display current account balance information when a user is initiating a cash transfer (the button 620 of FIG. 6) or approving a payment request (the button 820 of FIG. 8). Some cash transfer apps are directly linked to a client's bank account (e.g., a checking account) and directly credit and debit funds to/from that account, while other cash transfer apps maintain a balance within a user's account in the cash transfer app itself. Either way, before a user sends money using the CA$HSEND app, it may be advantageous to display the current balance in the corresponding account, or prevent the cash transfer if the amount exceeds the account balance, or both.

The illustrations of FIGS. 4-8 depict examples of the kind of actions and transactions that can be completed, simply and securely, using the NFC-enabled cash transfer app of the present disclosure. The cash sending and payment request transactions of FIGS. 6-8 may be performed after having established the two users as mutual contacts in the CA$HSEND app, or the cash sending and payment request transactions may be performed without the users being defined as contacts. For example, two strangers from different cites may meet and have drinks at a conference, where one needs to send cash to the other. They may use the cash send/request features discussed above without setting each other up as contacts, as they are not likely to see each other again. The cash transfer transaction in this scenario is still completely secure, based on the close physical proximity of the users' mobile devices and the inter-personal communication between the users, as discussed earlier.

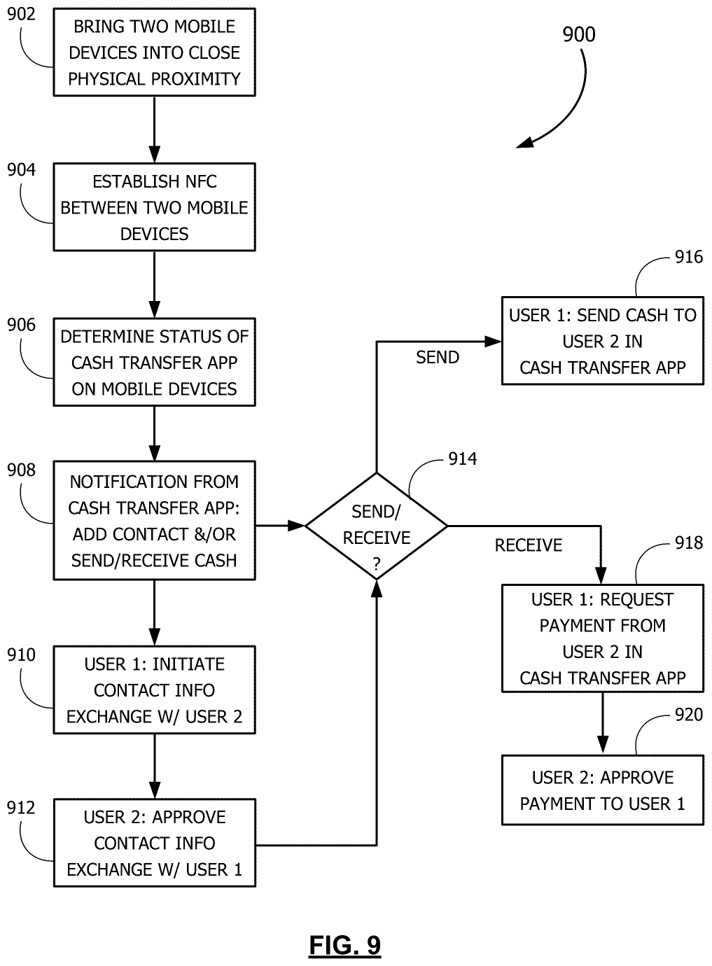

FIG. 9 is a flowchart diagram 900 of a method for establishing contacts and sending money using a cash transfer application on mobile devices communicating via near-field communication (NFC), according to an embodiment of the present disclosure. At box 902, two mobile devices are brought into close physical proximity and at box 904 NFC communication is established. This was depicted with the mobile devices 320 and 340 in FIG. 3. As discussed earlier, the mobile devices 320 and 340 have the cash transfer app installed or install it if necessary, and the mobile devices 320 and 340 are in communication with server computers which handle the back-end transactions for the cash transfer app. The communication with back-end servers may be via cellular communication networks, WiFi, or other suitable communication channel.

At box 906, at least one of the two mobile devices having the cash transfer app installed detects the other mobile device in close proximity (with NFC established), and begins a process of determining the status of the cash transfer app on the two mobile devices. This includes determining if the other mobile device has the cash transfer app installed and, if not, sending a notification to the other mobile device suggesting installation of the cash transfer app. When both mobile devices have the cash transfer app installed, the initiating mobile device determines whether the two users of the mobile devices are already established as cash transfer app contacts.

At box 908, at least one of the two mobile devices displays a message from the cash transfer app (e.g., the CASH$END app), providing actionable options for establishing the user of the other mobile device as a contact in the cash transfer app, or initiating a cash transfer with the other user, or both. If the two users are already set up as mutual contacts in the cash transfer app (as determined at the box 906), then the option to add contacts would not be displayed (or would be grayed out) in the notification provided at the box 908. Logic can be defined as deemed suitable for determining whether one or both mobile devices display the notification at the box 908. For example, if only one mobile device had the cash transfer app installed prior to the present interaction, then that user's device may be selected for displaying the notification. If only one user is lacking the other as a contact in the cash transfer app, then that user's device may be selected for displaying the notification.

At box 910, one of the users receiving the notification at the box 908 (this user is defined here as USER 1) initiates the exchange of contact information with the other user (defined as USER 2). This action at the box 910 would be performed by pressing the button 420 as shown on FIG. 4, for example. At box 912, USER 2 approves (or declines) the contact information exchange with USER 1. This action (approval) would be performed by pressing the button 520 as shown on FIG. 5, for example. The contact information exchange requires no further action by the users—such as trading texts or emails, manually entering data in the cash transfer app, entering securing codes, etc.—as in existing cash transfer apps which do not take advantage of the peer-to-peer inter-device communication and proximity using NFC.

At decision diamond 914, the at least one user who received the notification at the box 908 indicates whether to send cash to the other user or request a payment from the other user. The action at the decision diamond 914 may occur after the establishment of mutual contacts (i.e., after completion of the step at the box 912), or directly after receiving the notification at the box 908 (for example, if the two users are already mutual contacts, then the method proceeds directly to send/receive cash). Proceeding to the decision diamond 914 is performed by pressing the button 430 as shown on FIG. 4, for example. The indication whether to send cash to the other user or request a payment from the other user is performed by pressing the button 620 or the button 630 as shown on FIG. 6, for example.

At box 916, when send cash is selected at the decision diamond 914, USER 1 enters an amount of money to send and clicks a button in the cash transfer app to perform the cash send transaction. USER 1 in the box 916 need not necessarily be the same as USER 1 in the box 910. These monikers are simply used for convenience in the drawings. USER 2 will receive a notification in the cash transfer app indicating that USER 1 has sent the defined amount of cash, at which point USER 2 may simply click an acknowledgement button. These actions were shown on FIGS. 6 and 7.

At box 918, when receive cash (request payment) is selected at the decision diamond 914, USER 1 enters an amount of money to request as payment and clicks a button in the cash transfer app to send the payment request to USER 2. At box 920, USER 2 then receives a notification in the cash transfer app indicating that USER 1 has requested a payment in the defined amount, at which point USER 2 may approve or decline making the payment by selecting the corresponding button in the cash transfer app. The actions of the boxes 918 and 920 were shown on FIGS. 6 and 8.

As outlined in the preceding discussion and shown in the figures, the NFC-enabled cash transfer app of the present disclosure combines convenience and security to provide features not found in existing applications. The known close physical proximity of the two mobile devices is not only used to trigger the peer-to-peer interaction in the cash transfer app, but also ensures that any contact information exchange or cash transfer transaction is performed securely and only between the knowing participants, thereby allowing many inconvenient extra steps to be avoided by the users.

Particular embodiments and features of the disclosed methods and systems have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A method for improved inter-party communication using short range inter-device connectivity, said method comprising:
bringing two mobile devices into close physical proximity of less than five centimeters separation;
establishing near-field communication (NFC) between the two mobile devices;
detecting, by an application running on at least one of the mobile devices, that the NFC has been established;
triggering a notification to a user of the at least one mobile device, by the application upon detection of the NFC; and
taking an action by the user of the at least one mobile device by selecting an option on the notification provided by the application.

2. The method according to claim 1 wherein the mobile devices each have a processor and memory, NFC capability, and internet communication capability to a remote computing device which interacts with the mobile devices in running the application.

3. The method according to claim 1 wherein, after triggering a notification to a user of the at least one mobile device, ongoing communication and interaction between the two mobile devices is carried out using another, non-NFC, communication channel, where the other communication channel includes peer-to-peer WiFi or Bluetooth.

4. The method according to claim 1 wherein the application is a peer-to-peer cash transfer application, and the mobile device include a first and second mobile device.

5. The method according to claim 4 further comprising, after detecting that the NFC has been established, determining a status of the cash transfer application on the two mobile devices.

6. The method according to claim 5 wherein determining the status of the cash transfer application includes determining whether both of the mobile devices have the cash transfer application installed, and determining whether each mobile device user is established as a contact of each other mobile device user in the cash transfer application.

7. The method according to claim 4 wherein the notification is displayed on a display page on the first mobile device, the notification including a selectable option to add a user of the second mobile device as a contact in the cash transfer application, the notification further including a selectable option to send cash to the user of the second mobile device or request a payment from the user of the second mobile device.

8. The method according to claim 7 wherein, upon selection of the option to add the user of the second mobile device as a contact, the user of the second mobile device receives a notification of a request to share contact information which may be approved or declined.

9. The method according to claim 7 wherein, upon selection of the option to send cash to the user of the second mobile device, an available account balance for the user of the first mobile device is displayed along with a prompt to enter a cash send amount, and the user of the second mobile device receives a notification of receipt of the cash send amount.

10. The method according to claim 7 wherein, upon selection of the option to request a payment from the user of the second mobile device, a prompt to enter a payment request amount is displayed to the user of the first mobile device, the user of the second mobile device receives a notification of the payment request amount along with an available account balance for the user of the second mobile device, and the notification of the payment request amount may be approved or declined by the user of the second mobile device.

11. A method for operating a peer-to-peer cash transfer application enabled by near-field communication, said method comprising:
bringing first and second mobile devices into close physical proximity of less than five centimeters separation, where the mobile devices include internet communication capability to a remote computing device which interacts with the mobile devices in running the cash transfer application;
establishing near-field communication (NFC) between the mobile devices;
detecting, by the cash transfer application running on at least one of the mobile devices, that the NFC has been established;
establishing a secondary communication channel between the mobile devices, the secondary communication channel being used for ongoing communication and interaction between the mobile devices, where the secondary communication channel includes peer-to-peer WiFi or Bluetooth;
determining a status of the cash transfer application on the mobile devices, including determining whether both of the mobile devices have the cash transfer application installed, and determining whether each mobile device user is established as a contact of each other mobile device user in the cash transfer application;
triggering a notification to a user of the first mobile device, by the cash transfer application upon detection of the NFC, including a selectable option to add a user of the second mobile device as a contact in the cash transfer application, and a selectable option to send cash to the user of the second mobile device or request a payment from the user of the second mobile device;
taking an action by the user of the first mobile device by selecting one of the options on the notification provided by the application; and
triggering a notification to the user of the second mobile device, by the cash transfer application upon taking the action by the user of the first mobile device, including a selectable option to approve sharing contact information with the user of the first mobile device, and a selectable option to approve a payment request from the user of the first mobile device.

12. A peer-to-peer cash transfer application system enabled by near-field communication, said system comprising:
first and second mobile devices each including a processor, memory and near-field communication (NFC) capability, the mobile devices further including internet communication to a remote computing device which interacts with the mobile devices in running the cash transfer application,
where the cash transfer application is configured for performing steps including;
detecting that NFC has been established between the mobile devices, where the NFC is established upon the mobile devices being brought into close physical proximity of less than five centimeters separation;
triggering a notification to a user of the first mobile device, by the cash transfer application upon detection of the NFC; and
recording an action taken by the user of the first mobile device, where the action is taken by selecting an option on the notification provided by the application.

13. The system according to claim 12 wherein the internet communication is carried over a cellular communication network, a WiFi channel connected to an internet service provider network, or both.

14. The system according to claim 12 wherein, after triggering a notification to the user of the first mobile device, ongoing communication and interaction between the mobile devices is carried out using another, non-NFC, communication channel, where the other communication channel includes peer-to-peer WiFi or Bluetooth.

15. The system according to claim 12 further comprising, after detecting that the NFC has been established, determining a status of the cash transfer application on the mobile devices.

16. The system according to claim 15 wherein determining the status of the cash transfer application includes determining whether both of the mobile devices have the cash transfer application installed, and determining whether each mobile device user is established as a contact of each other mobile device user in the cash transfer application.

17. The system according to claim 12 wherein the notification is displayed on a display page on the first mobile device, the notification including a selectable option to add a user of the second mobile device as a contact in the cash transfer application, the notification further including a selectable option to send cash to the user of the second mobile device or request a payment from the user of the second mobile device.

18. The system according to claim 17 wherein, upon selection of the option to add the user of the second mobile device as a contact, the user of the second mobile device receives a notification of a request to share contact information which may be approved or declined.

19. The system according to claim 17 wherein, upon selection of the option to send cash to the user of the second mobile device, an available account balance for the user of the first mobile device is displayed along with a prompt to enter a cash send amount, and the user of the second mobile device receives a notification of receipt of the cash send amount.

20. The system according to claim 17 wherein, upon selection of the option to request a payment from the user of the second mobile device, a prompt to enter a payment request amount is displayed to the user of the first mobile device, the user of the second mobile device receives a notification of the payment request amount along with an available account balance for the user of the second mobile device, and the notification of the payment request amount may be approved or declined by the user of the second mobile device.
